(19) United States
(12) Patent Application Publication
(10) Pub. No.: US 2026/0035547 A1
(43) Pub. Date: Feb. 5, 2026

(54) RUBBER COMPOSITION

(71) Applicant: The Yokohama Rubber Co., LTD., Kanagawa (JP)

(72) Inventor: Ryutaro NAKAGAWA, Kanagawa (JP)

(21) Appl. No.: 19/100,780

(22) PCT Filed: Aug. 10, 2023
(86) PCT No.: PCT/JP2023/029284

§ 371 Date: Feb. 3, 2025

(30) Foreign Application Priority Data
Aug. 10, 2022 (JP) 2022-127865

(51) Int. Cl. C08L 15/00

(52) U.S. Cl. CPC C08L 15/00; C08L 2203/30; C08L 2205/025; C08L 2205/035; C08L 2205/08

(57) ABSTRACT

A rubber composition contains from 20 to 150 parts by mass of a white filler, and a total of 20 to less than 50 parts by mass of a thermoplastic resin and, optionally, a plasticizer, in 100 parts by mass of a diene rubber containing a styrene-butadiene rubber, where the thermoplastic resin accounts for 75 mass % or more with respect to the total amount. The rubber composition satisfies |σbf-σaf≥4 and |tan δbf-tan δaf|≤0.02, where σbf (° C.) represents a half-width in a temperature dependent tan δ curve of the rubber composition, tan δb represents tan δ at a temperature 90° C. higher than a peak temperature where tan δ is at maximum, σaf (° C.) represents a half-width of a temperature dependent tan δ curve of a treated rubber composition by immersion of the rubber composition in toluene and drying, and tan δaf represents tan δ at a temperature 90° C. higher than a peak temperature where tan δ is at maximum.

### TECHNICAL FIELD

The present technology relates to a rubber composition providing wear resistance, low rolling resistance, and wet performance in a compatible manner.

### BACKGROUND ART

A tire is required to have high levels of wear resistance, low rolling resistance, and wet performance. For a rubber composition for a tire tread with improved wear resistance, low rolling resistance, and wet performance, blending of an aromatic modified terpene resin and an oil in the rubber composition has been proposed (e.g., see Japan Unexamined Patent Publication No. 2013-166864 A).

However, in recent years, wear resistance, low rolling resistance, and wet performance are required to be provided in a well-balanced, compatible manner at higher levels than levels described in Japan Unexamined Patent Publication No. 2013-166864 A.

### SUMMARY

The present technology provides a rubber composition that achieves wear resistance, low rolling resistance, and wet performance in a compatible manner at higher levels than known levels.

A rubber composition according to an embodiment of the present technology may contain: in 100 parts by mass of a diene rubber containing at least one styrene-butadiene rubber, from 20 to 150 parts by mass of a white filler, and a total of 20 parts by mass or more and less than 50 parts by mass of a thermoplastic resin and, optionally, a plasticizer; a proportion of the thermoplastic resin with respect to a total amount of the thermoplastic resin and the plasticizer being 75 mass % or more; and the rubber composition satisfying relationship formulas (1) and (2) below:

$$\vert σ bf - σ af \vert \geq 4 \qquad ( 1 )$$

$$\vert tan δ bf - tan δ af \vert \leq 0.02 \qquad ( 2 )$$

where σbf (° C.) represents a half-width in a temperature dependent tan δ curve of the rubber composition, tan δbf represents a value of tan δ at a temperature 90° C. higher than a peak temperature where tan δ is at maximum, σaf (° C.) represents a half-width in a temperature dependent tan δ curve of a treated rubber composition by immersion of the rubber composition in toluene and drying, and tan δaf represents a value of tan δ at a temperature 90° C. higher than a peak temperature where tan δ is at maximum.

The rubber composition according to an embodiment of the present technology contains the thermoplastic resin and the plasticizer at the specific blending ratios in the styrene-butadiene rubber and the white filler. Between the rubber composition and the treated rubber composition by immersion of the rubber composition in toluene and drying, the half-width σ of temperature dependent tan δ curve and tan δ at the temperature 90° C. higher than a peak temperature where tan δ is at maximum satisfy a specific relationship, and thus wear resistance, low rolling resistance, and wet performance can be provided in a compatible manner at higher levels than known levels.

A difference Tgr-Tgp between a minimum glass transition temperature Tgp (° C.) among glass transition temperatures of the at least one styrene-butadiene rubber and the glass transition temperature Tgr (° C.) of the thermoplastic resin is preferably 100° C. or more, to achieve even better wear resistance.

The diene rubber preferably contains from 70 to 100 mass % of the at least one styrene-butadiene rubber and from 0 to 30 mass % of an isoprene-based rubber, and at least one of terminals of the at least one styrene-butadiene rubber is preferably modified with a functional group.

The thermoplastic resin preferably has a glass transition temperature Tgr of from 40° C. to 120° C. Further, the thermoplastic resin is preferably at least one selected from the group consisting of a resin containing at least one selected from a terpene, a modified terpene, a rosin, a rosin ester, a C5 component, and a C9 component, and a resin with at least some of double bonds of the resin being hydrogenated.

### DETAILED DESCRIPTION

The rubber composition according to an embodiment of the present technology contains at least one styrene-butadiene rubber as the diene rubber. One type of styrene-butadiene rubber may be contained alone, or a blend of two or more types of styrene-butadiene rubbers may be contained. Including the styrene-butadiene rubber not only increases tensile strength at break and wear resistance, but also improves the dispersibility of silica, resulting in a larger tan δ at 0° C. and excellent wet performance.

The styrene-butadiene rubber has a glass transition temperature (hereinafter, which may be described as “Tg”) of preferably from −55° C. or lower, more preferably from −80° C. to −58° C., and even more preferably from −75° C. to −60° C. The Tg of the styrene-butadiene rubber of −55° C. or lower is preferred, which can improve the wear resistance. The Tg of the styrene-butadiene rubber can be determined as the temperature at the midpoint of the transition region on a thermogram obtained by differential scanning calorimetry (DSC) at a heating rate of 20° C./min. When the styrene-butadiene rubber is an oil extended product, the Tg of the styrene-butadiene rubber is measured in a state where the oil-extending component (the oil) is not included.

The styrene content of the styrene-butadiene rubber is not particularly limited and is preferably from 5 to 45 mass %, and more preferably from 8 to 42 mass %. Setting the styrene content within these ranges improves wear resistance and is preferred.

The vinyl content of the styrene-butadiene rubber is not particularly limited and is preferably from 5 to 60%, and more preferably from 10 to 55%. Setting the vinyl content within these ranges results in excellent dry grip performance and is preferred. The styrene content and the vinyl content in the styrene-butadiene rubber can be measured by 1H-NMR.

At least one terminal of the styrene-butadiene rubber is preferably modified with a functional group, which can improve the dispersibility of silica and further reduce the tire rolling resistance. Examples of the functional group include an epoxy group, a carboxy group, an amino group, a hydroxy group, an alkoxy group, a silyl group, an alkoxysilyl group, an amide group, an oxysilyl group, a silanol group, an isocyanate group, an isothiocyanate group, a carbonyl group, and an aldehyde group, among which, a functional group having a polyorganosiloxane structure or an aminosilane structure is preferable. The presence of the functional group having the polyorganosiloxane structure or the aminosilane structure can improve the dispersibility of silica and enhance wear resistance, low rolling resistance, and wet performance.

The content of the styrene-butadiene rubber is preferably 55 mass % or more, more preferably from 70 to 100 mass %, and even more preferably from 75 to 90 mass %, in 100 mass % of the diene rubber. The content of the styrene-butadiene rubber refers to the content of the styrene-butadiene rubber when one type of styrene-butadiene rubber is contained alone, and to the total amount of styrene-butadiene rubbers when a blend of two or more types of styrene-butadiene rubbers is contained. Containing 55 mass % or more of the styrene-butadiene rubber can improve the dispersibility of silica and enhance wear resistance and wet performance.

The rubber composition can optionally contain another diene rubber besides the styrene-butadiene rubber. Examples of the other diene rubber can include natural rubber, isoprene rubber, butadiene rubber, butyl rubber, halogenated butyl rubber, acrylonitrile-butadiene rubber, and a modified rubber obtained by modifying the rubber mentioned with a functional group. In an embodiment of the present technology, the rubber composition preferably contains no butadiene rubber, thereby achieving the improvement in wet performance and wear resistance. The other diene rubber may be used alone or as a blend. The content of the other diene rubber is preferably 45 mass % or less, more preferably from 0 to 30 mass %, and even more preferably from 10 to 25 mass %, in 100 mass % of the diene rubber.

The rubber composition preferably contains an isoprene-based rubber such as natural rubber or isoprene rubber to improve wear resistance. The isoprene-based rubber is preferably in an amount from 0 to 30 mass %, and more preferably from 10 to 25 mass %, in 100 mass % of the diene rubber. Natural rubber and the like that are typically used in a rubber composition may be used as the isoprene-based rubber.

Blending a white filler in the diene rubber improves wet performance of the rubber composition. Examples of the white filler include silica, calcium carbonate, magnesium carbonate, talc, clay, alumina, aluminum hydroxide, titanium oxide, and calcium sulfate. These can be used alone or in combination of two or more types. Silica is preferable among these for achieving more excellent wet performance and low heat build-up. The white filler is blended in an amount from 20 to 150 parts by mass, preferably from 40 to 150 parts by mass, and more preferably from 60 to 140 parts by mass per 100 parts by mass of the diene rubber. Blending 20 parts by mass or more of the white filler can achieve more excellent wet performance and wear resistance. Blending 150 parts by mass or less of the white filler can achieve excellent wear resistance and low rolling resistance.

As the silica, silica typically used in a rubber composition is preferably used. Examples that can be used include wet silica, dry silica, carbon-silica (dual-phase filler) in which silica is supported on a carbon black surface, and silica that is surface-treated with a compound that is reactive or miscible with both silica and rubber, such as a silane coupling agent or polysiloxane. Among these, a wet silica having hydrous silicic acid as a main component is preferred.

Furthermore, blending a silane coupling agent together with silica is preferred because the dispersibility of the silica is enhanced, and the wet performance and the low heat build-up are further improved. The type of silane coupling agent is not particularly limited and is preferably a sulfur-containing silane coupling agent, and examples thereof can include bis-(3-triethoxysilylpropyl) tetrasulfide, bis(3-triethoxysilylpropyl)trisulfide, bis(3-triethoxysilylpropyl) disulfide, bis(2-triethoxysilylethyl)tetrasulfide, bis(3-trimethoxysilylpropyl) tetrasulfide, bis(2-trimethoxysilylethyl)tetrasulfide, mercaptosilane compounds exemplified in JP 2006-249069 A such as 3-mercaptopropyltrimethoxysilane, 3-mercaptopropyldimethoxymethylsilane, 3-mercaptopropyldimethylmethoxysilane, 2-mercaptoethyltriethoxysilane, 3-mercaptopropyltriethoxysilane, and VP Si363 available from Evonik Co., 3-trimethoxysilylpropylbenzothiazole tetrasulfide, 3-triethoxysilylpropylbenzothiazolyl tetrasulfide, 3-triethoxysilylpropylmethacrylate monosulfide, 3-trimethoxysilylpropylmethacrylate monosulfide, 3-trimethoxysilylpropyl-N, N-dimethylthiocarbamoyl tetrasulfide, 3-triethoxysilylpropyl-N,N-dimethylthiocarbamoyl tetrasulfide, 2-triethoxysilylethyl-N,N-dimethylthiocarbamoyl tetrasulfide, bis(3-diethoxymethylsilylpropyl) tetrasulfide, dimethoxymethylsilylpropyl-N,N-dimethylthiocarbamoyl tetrasulfide, dimethoxymethylsilylpropylbenzothiazolyl tetrasulfide, 3-octanylthiopropyltriethoxysilane, 3-propionylthiopropyltrimethoxysilane, vinyltrimethoxysilane, vinyltriethoxysilane, vinyltris(2-methoxyethoxy) silane, 3-glycidoxy propyltrimethoxysilane, 3-glycidoxypropylmethyldimethoxysilane, β-(3,4-epoxycyclohexyl)ethyltrimethoxysilane, 3-aminopropyltrimethoxysilane, N-(β-aminoethyl)-γ-aminopropyltrimethoxysilane, and N-(β-aminoethyl)-γ-aminopropylmethyldimethoxysilane.

The silane coupling agent is preferably blended in an amount from 3 to 20 mass %, and more preferably from 5 to 15 mass %, with respect to the mass of silica. Blending the silane coupling agent in an amount of 3 mass % or more with respect to the mass of silica is advantageous for improving the dispersibility of silica. Blending the silane coupling agent in an amount of 20 mass % or less can suppress gelification of the diene rubber component, thereby providing a desired effect.

Blending another filler in addition to the white filler in the rubber composition can enhance the strength of the rubber composition and ensure tire durability. Examples of the other filler can include an inorganic filler such as carbon black, mica, aluminum oxide, and barium sulfate; and an organic filler such as cellulose, lecithin, lignin, and dendrimer.

In particular, blending the carbon black can result in excellent strength of the rubber composition. As the carbon black, a carbon black such as furnace black, acetylene black, thermal black, channel black, and graphite can be blended. Among these, furnace black is preferred. Specific examples thereof include SAF (Super Abrasion Furnace), ISAF (Intermediate Super Abrasion Furnace), ISAF-HS (Intermediate Super Abrasion Furnace-High Structure), ISAF-LS (Intermediate Super Abrasion Furnace-Low Structure), HSAF-HS (Intermediate Intermediate Super Abrasion Furnace-High Structure), HAF (High Abrasion Furnace), HAF-HS (High Abrasion Furnace-High Structure), HAF-LS (High Abrasion Furnace-Low Structure) and FEF (Fast Extruding Furnace). These carbon blacks may be used alone or in combination of two or more types thereof. Surface-treated carbon blacks in which these carbon blacks are chemically modified with various acid compounds can also be used.

When the rubber composition contains a specific thermoplastic resin and, optionally, a plasticizer, the temperature dependence of dynamic viscoelasticity can be adjusted. The total amount of the thermoplastic resin and the plasticizer is 20 parts by mass or more and less than 50 parts by mass per 100 parts by mass of the diene rubber. That is, the thermoplastic resin may be blended in an amount of 20 parts by mass or more and less than 50 parts by mass without a plasticizer, or the plasticizer may be contained and the total blended amount of the thermoplastic resin and the plasticizer may be 20 parts by mass or more and less than 50 parts by mass. Blending the thermoplastic resin and the plasticizer in this range can provide wear resistance and low rolling resistance in a compatible manner. The total amount of the thermoplastic resin and the plasticizer is preferably 25 parts by mass or more and 48 parts by mass or less, and more preferably 30 parts by mass or more and 45 parts by mass or less.

The rubber composition has a proportion of the thermoplastic resin of 75 mass % or more, with respect to the total amount of the thermoplastic resin and the plasticizer. Setting the proportion of the thermoplastic resin to 75 mass % or more can improve wear resistance. The proportion of the thermoplastic resin with respect to the total amount of the thermoplastic resin and the plasticizer is preferably 80 mass % or more and 100 mass % or less, and more preferably 85 mass % or more and 100 mass % or less.

The thermoplastic resin is a resin typically blended in a rubber composition and has a function of imparting adhesiveness to the rubber composition. The thermoplastic resin is preferably at least one selected from the group consisting of a resin that consists of at least one selected from a terpene, a modified terpene, a rosin, a rosin ester, a C5 component, and a C9 component, and a resin with at least some of double bonds of the resin mentioned being hydrogenated. Examples of the resin include a natural resin such as a terpene resin, a modified terpene resin, a rosin resin, and a rosin ester resin; and a synthetic resin such as a petroleum resin including a C5 component and a C9 component, a coal resin, a phenolic resin, and a xylene-based resin. In addition, the thermoplastic resin may be a resin with at least some of double bonds of the resin mentioned being hydrogenated.

Examples of the terpene resin include α-pinene resin. β-pinene resin, limonene resin, hydrogenated limonene resin, dipentene resin, terpene styrene resin, an aromatic modified terpene resin, and a hydrogenated terpene resin. Examples of the rosin resin include a modified rosin such as gum rosin, tall oil rosin, wood rosin, hydrogenated rosin, disproportionated rosin, polymerized rosin, maleinized rosin, and fumarized rosin; an ester derivative of these rosins, such as a glycerin ester, a pentaerythritol ester, a methyl ester, and a triethylene glycol ester; and a rosin modified phenol resin.

Examples of the petroleum resin include an aromatic hydrocarbon resin or, alternatively, a saturated or unsaturated aliphatic hydrocarbon resin. Examples thereof include a C5 petroleum resin (an aliphatic petroleum resin polymerized from fractions such as isoprene, 1,3-pentadiene, cyclopentadiene, methylbutene, and pentene), a C9 petroleum resin (an aromatic petroleum resin polymerized from fractions such as α-methylstyrene, o-vinyltoluene, m-vinyltoluene, and p-vinyltoluene), and a C5C9 copolymerized petroleum resin.

The thermoplastic resin has a glass transition temperature Tgr (° C.) of preferably from 40° C. to 120° C., preferably from 45° C. to 115° C., and more preferably from 50° C. to 110° C. A glass transition temperature Tgr of the thermoplastic resin of 40° C. or higher is preferred for improving dry grip performance. Additionally, a glass transition temperature Tgr of the thermoplastic resin of 120° C. or lower is preferred for improving wear resistance.

A difference Tgr-Tgp between the glass transition temperature Tgr of the thermoplastic resin and a minimum glass transition temperature Tgp (° C.) among the glass transition temperatures of the at least one styrene-butadiene rubber is preferably 100° C. or more, at which superior wear resistance can be achieved. The difference Tgr-Tgp of the glass transition temperatures is more preferably 105° C. or more, and more preferably 110° C. or more. In the present description, the glass transition temperatures of the diene rubber and the thermoplastic resin are determined as the temperature at the midpoint of the transition region on a thermogram measured by differential scanning calorimetry (DSC) at a heating rate of 20° C./min.

In the present description, the plasticizer refers to an oil component and a liquid rubber contained in the rubber composition. The oil component refers to a total of an oil blended during preparation of the rubber composition and an oil contained as an oil-extending component in the diene rubber. The oil component may be a natural oil or a synthetic oil.

The liquid rubber refers to a rubber that is liquid at 23° C. Therefore, it is distinguished from the diene rubber described above that is solid at 23° C. Examples of the liquid rubber include liquid polybutadiene, liquid polystyrene-butadiene, and liquid polyisoprene. The liquid rubber has a number average molecular weight (Mn) of preferably 1000 or more and less than 50000, more preferably from 5000 to 40000, and even more preferably from 10000 to 30000. A specific relationship is satisfied between the respective temperature dependent tan δ (loss tangent) curves of the rubber composition according to an embodiment of the present technology and the treated rubber composition by immersion of the rubber composition in toluene and drying. That is, the following relationship formulas (1) and (2) are satisfied with σbf (° C.) representing a half-width in the temperature dependent tan δ curve of the rubber composition, tan δbf representing a value of tan δ at a temperature 90° C. higher than a peak temperature where tan δ is at maximum, σaf (° C.) representing a half-width in the temperature dependent tan δ curve of the treated rubber composition by immersion of the rubber composition in toluene and drying, and tan δaf representing a value of tan δ at a temperature 90° C. higher than a peak temperature where tan δ is at maximum.

$$\vert σ bf - σ af \vert \geq 4 \qquad ( 1 )$$

$$\vert tan δ bf - tan δ af \vert \leq 0.02 \qquad ( 2 )$$

The temperature dependent tan δ curve of the rubber composition can be determined as a viscoelasticity curve with the horizontal axis representing a measurement temperature and the vertical axis representing loss tangent (tan 8) by measuring a dynamic viscoelasticity of a cured product of the rubber composition of a predetermined shape (a 2 mm thick sheet obtained by vulcanization at 160° C. for 25 minutes) using a viscoelasticity spectrometer under conditions of an elongation deformation strain of 10±2%, a vibration frequency of 20 Hz, and a temperature of −80° C. to 100° C. From the obtained temperature dependent tan δ curve, a maximum value of tan δ (peak value) and the corresponding temperature (peak temperature) are determined. The half-width σbf of tan δ is determined as a temperature difference between a high temperature side and a low temperature side when tan δ is half of the peak value. Furthermore, a value of tan δ at a temperature 90° C. higher than the peak temperature is determined as tan δbf.

The treated rubber composition by immersion of the rubber composition in toluene and drying is prepared by immersing the cured product of the rubber composition in toluene and drying it. That is, a 2 mm thick sheet (approximately 30 g) obtained by vulcanizing the rubber composition at 160° C. for 25 minutes is immersed in 200 mL of toluene and allowed to stand at room temperature (23° C.) for 48 hours, thereby dissolving and removing the thermoplastic resin and the plasticizer. Then, the removed sheet is immersed in 200 mL of acetone and allowed to stand at room temperature (23° C.) for 48 hours, thereby replacing toluene with acetone. Thereafter, the removed sheet is dried at room temperature (23° C.) for 48 hours to remove acetone, and the treated rubber composition by immersion in toluene and drying can be obtained.

The temperature dependent tan δ curve of the treated rubber composition can be determined as a viscoelasticity curve with the horizontal axis representing a measurement temperature and the vertical axis representing loss tangent (tan δ) by measuring the dynamic viscoelasticity of the cured product obtained as described above of a predetermined shape using a viscoelasticity spectrometer under conditions of an elongation deformation strain of 10±2%, a vibration frequency of 20 Hz, and a temperature of −80° C. to 100° C. From the obtained temperature dependent tan δ curve of the treated rubber composition, a maximum value of tan δ (peak value) and the corresponding temperature (peak temperature) are determined. The half-width σaf of tan δ is determined as a temperature difference between a high temperature side and a low temperature side when tan δ is half of the peak value. Furthermore, a value of tan δ at a temperature 90° C. higher than the peak temperature is determined as tan δaf.

The difference |σbf-σaf| between the half-width σbf of tan δ of the rubber composition and the half-width σaf of tan δ of the treated rubber composition is 4° C. or more, preferably from 6° C. to 15° C., and more preferably from 6° C. to 10° C. When the difference |σbf-σaf| is in this range, wear resistance can be improved without reduction in wet performance. The rubber composition that satisfies the difference | σbf-σaf| of 4° C. or more can be prepared by blending the thermoplastic resin and the optional plasticizer in the specific mass proportions in the diene rubber containing a styrene-butadiene rubber having a low glass transition temperature with a large difference from the glass transition temperature of the thermoplastic resin.

The difference |tan δbf-tan δaf| between the value of tan δbf of tan δ at the temperature 90° C. higher than the peak temperature where tan δ of the rubber composition is at maximum and a value of tan δaf of tan δ at the temperature 90° C. higher than the peak temperature where tan δ of the treated rubber composition is at maximum is 0.02 or less, and preferably 0.015 or less. The difference | tan δbf-tan δaf| in this range can improve wear resistance without deteriorating low rolling resistance. The rubber composition satisfying the difference | tan δbf-tan δaf| of 0.02 or less can be prepared by blending a diene rubber and a thermoplastic resin having good affinity with each other. For example, a rubber composition containing a thermoplastic resin having a low miscibility with a diene rubber results in a large value of tan δbf and a difference | tan δbf-tan δaf| of more than 0.02. As a result, tan δ at 60° C., which is an indicator of rolling resistance, increases.

In addition to the components described above, various compounding agents that are commonly used in rubber compositions for tires can be blended in the rubber composition in accordance with an ordinary method. Examples of the compounding agents include a vulcanization or crosslinking agent, a vulcanization accelerator, an anti-aging agent, a processing aid, and a thermosetting resin. These compounding agents can be kneaded by a common method to obtain a rubber composition that can then be used for vulcanization or crosslinking. These compounding agents can be blended in known and typical amounts provided that the present technology is not hindered. The rubber composition can be prepared by mixing the above-mentioned components using a known rubber kneading machine such as a Banbury mixer, a kneader, or a roller.

The rubber composition is suitable for forming a tread portion or a side portion of a tire and especially suitable for forming a tread portion of a tire. The tire obtained in this way can provide wear resistance, low rolling resistance, and wet performance in a compatible manner at higher levels than known levels.

Embodiments according to the present technology are further described below by Examples. However, the scope of the present technology is not limited to these Examples.

### EXAMPLES

For preparing 15 types of rubber compositions (Standard Example, Examples 1 to 8, and Comparative Examples 1 to 6) containing the common additive formulation listed in Table 3 and having one of the compositions listed in Tables 1 and 2, components other than sulfur and the vulcanization accelerator were weighed and kneaded in a 1.7 L sealed Banbury mixer for 5 minutes. Then, the resulting master batch was discharged outside the mixer and cooled at room temperature. The master batch was placed in the Banbury mixer, and sulfur and a vulcanization accelerator were then added and mixed to obtain each of the rubber compositions. Note that the additive formulation in Table 3 is expressed as values in parts by mass per 100 parts by mass of the diene rubbers listed in Tables 1 and 2.

In addition, in Tables 1 and 2, the total amount of the thermoplastic resin and the plasticizer (oil and liquid rubber) was calculated and listed in rows of “resin+plasticizer”. The mass proportion of the thermoplastic resin with respect to the total amount of the thermoplastic resin and the plasticizer was calculated and listed in rows of “resin mass proportion”. Furthermore, for the rubber compositions of Examples and Comparative Examples described above, the difference Tgr-Tgp between a minimum glass transition temperature Tgp (° C.) among the glass transition temperatures of the styrene-butadiene rubbers and the glass transition temperature Tgr (° C.) of the thermoplastic resin was calculated and listed in rows of “difference Tgr-Tgp” in Tables 1 and 2. Measurement of Half-Width σbf of Temperature Dependent tan δ Curve of

### Rubber Composition and tan δbf

Each of the rubber compositions obtained as described above was vulcanized in a mold of a predetermined shape at 160° C. for 25 minutes, and thus evaluation samples (2 mm thick sheets) for dynamic viscoelasticity (loss tangent tan δ) were prepared. tan δ of each of the obtained evaluation samples was measured with a viscoelasticity spectrometer available from Iwamoto Seisakusho K.K. under conditions of an elongation deformation strain of 10±2%, a vibration frequency of 20 Hz, and a temperature of −80° C. to 100° C., and a temperature dependent tan δ curve at −80° C. to 100° C. was created with the horizontal axis representing a measurement temperature and the vertical axis representing loss tangent (tan δ). From the obtained temperature dependent tan δ curve, a maximum value of tan δ (peak value) and the corresponding temperature (peak temperature) were determined. The half-width σbf of tan δ was determined as a temperature difference between a high temperature side and a low temperature side when tan δ was half of the peak value. Furthermore, a value of tan δ at a temperature 90° C. higher than the peak temperature, at which tan δ showed the peak value, was determined as tan σbf.

Measurement of Half-Width σaf of Temperature Dependent tan δ Curve of Toluene-treated Rubber Composition and tan δaf 2 mm thick sheets (approximately 30 g) obtained by vulcanizing the rubber compositions listed in Tables 1 and 2 at 160° C. for 25 minutes were immersed in 200 mL of toluene and allowed to stand at room temperature (23° C.) for 48 hours, thereby dissolving and removing the thermoplastic resin and the plasticizer. Then, the removed sheets were immersed in 200 ml of acetone and allowed to stand at room temperature (23° C.) for 48 hours, thereby replacing toluene with acetone. Thereafter, the removed sheets were dried at room temperature (23° C.) for 48 hours to remove acetone, and thus evaluation samples of the treated rubber compositions by immersion in toluene and drying were obtained.

tan δ of each of the evaluation samples of the treated rubber compositions obtained as described above was measured with a viscoelasticity spectrometer available from Iwamoto Seisakusho K.K. under conditions of an elongation deformation strain of 10±2%, a vibration frequency of 20 Hz, and a temperature of −80° C. to 100° C., and a temperature dependent tan δ curve at −80° C. to 100° C. was created with the horizontal axis representing a measurement temperature and the vertical axis representing loss tangent (tan δ). From the obtained temperature dependent tan δ curve, a maximum value of tan δ (peak value) and the corresponding temperature (peak temperature) were determined. The half-width σaf of tan δ of each of the treated rubber compositions was determined as a temperature difference between a high temperature side and a low temperature side when tan δ was half of the peak value. Furthermore, a value of tan δ at a temperature 90° C. higher than the peak temperature, at which tan δ of the treated rubber composition showed the peak value, was determined as tan δaf.

From the half-width σbf of tan δ of the rubber composition and the half-width σaf of tan δ of the treated rubber composition obtained as described above, |σbf-σaf| was calculated and listed in rows of “difference | σbf-σaf|” in Tables 1 and 2. From the value of tan δbf of tan δ at a temperature 90° C. higher than the peak temperature of tan δ of the rubber composition and the value of tan δaf of tan δ at a temperature 90° C. higher than the peak temperature of tan δ of the treated rubber composition, |tan δbf-tan δaf| was calculated and listed in rows of “difference |tan δbf-tan δaf|” in Tables 1 and 2.

Using the rubber composition obtained as described above in a tire tread, a pneumatic tire of size 205/55R16 was vulcanized and molded. The wear resistance, wet performance, and rolling resistance of the obtained tires were measured by the following methods.

### Wear Resistance

The obtained tires were assembled on wheels of a standard rim size and mounted on a rolling resistance tester provided with an 854 mm-radius drum, pre-running was performed for 30 minutes under conditions of an air pressure of 210 kPa, a load of 100 N, a speed of 80 km/h, and a drum surface temperature of 20° C., and then running test was performed at a speed of 100 km/h for 20000 km. Thereafter, an amount of wear of a tread land portion was measured. For the evaluation results, reciprocals of measured values were calculated and expressed as index values with an index value of Standard Example set at 100, which are listed in rows of “wear resistance” in Tables 1 and 2. A larger index value indicates less amount of wear and excellent wear resistance, and an index value of 110 or more is suitable.

### Wet Performance

The obtained tires were assembled on standard rims and mounted on a test vehicle equipped with ABS (anti-lock braking system) and having an engine displacement of 2000 cc, and the air pressures of the front tire and the rear tire were set to 220 kPa. The test vehicle was driven on an asphalt road surface sprayed with water to a depth of from 2.0 to 3.0 mm, and a braking/stopping distance from a speed of 100 km/h was measured. Reciprocals of the obtained results were calculated and expressed as index values with an index value of Standard Example set as 100, which are listed in rows of “wet performance” in Tables 1 and 2. A larger index value indicates a shorter braking/stopping distance and excellent wet performance, and an index value of 110 or more is suitable.

### Rolling Resistance

The obtained tires were assembled on wheels with a standard rim size and mounted on a rolling resistance tester provided with an 854 mm-radius drum. After pre-running was performed for 30 minutes under conditions of an air pressure of 210 kPa, a load of 100 N, a speed of 80 km/h, and a drum surface temperature of 20° C., rolling resistance was measured under the same conditions. For the evaluation results, reciprocals of measured values were used as index values with an index value of Standard Example set as 100, which are listed in rows of “rolling resistance” in Tables 1 and 2. A larger index value indicates lower rolling resistance and excellent performance, and an index value of 95 or more is suitable.

TABLE 1-1

| | | Standard | Comparative | Comparative | Comparative |
|---|---|---|---|---|---|
| | | Example | Example 1 | Example 2 | Example 3 |
| NR | Parts by mass | | | | |
| SBR-1 | Parts by mass | 50 | 60 | 60 | 75 |
| SBR-2 | Parts by mass | 50 | 40 | 40 | 25 |
| SBR-3 | Parts by mass | | | | |
| Carbon black | Parts by mass | 10 | 10 | 10 | 10 |
| Silica | Parts by mass | 90 | 90 | 90 | 90 |
| Coupling agent | Parts by mass | 9 | 9 | 9 | 9 |
| Resin-1 | Parts by mass | | 5 | 8 | |
| Resin-2 | Parts by mass | | | | |
| Resin-3 | Parts by mass | | | | |
| Resin-4 | Parts by mass | | | | 35 |
| Liquid rubber | Parts by mass | | | | |
| Oil | Parts by mass | 40 | 35 | 2 | 5 |
| Resin + plasticizer | (parts by mass) | 40 | 40 | 10 | 40 |
| Resin mass proportion | % | 0 | 12.5 | 80 | 87.5 |
| Difference Tgr − Tgp | ° C. | — | 119 | 119 | 156 |
| Difference \|σbf − σaf\| | ° C. | — | 1 | 2 | 18 |
| Difference \|tanδbf − tanδaf\| | — | — | 0.005 | 0.008 | 0.150 |
| Wear resistance | Index value | 100 | 105 | 105 | 115 |
| Wet performance | Index value | 100 | 102 | 105 | 95 |
| Rolling resistance | Index value | 100 | 100 | 99 | 88 |

TABLE 1-2

| | | Compar- | Compar- | Compar- |
|---|---|---|---|---|
| | | ative | ative | ative |
| | | Example 4 | Example 5 | Example 6 |
| NR | Parts by mass | | | |
| SBR-1 | Parts by mass | 95 | 80 | 80 |
| SBR-2 | Parts by mass | 5 | 20 | 20 |
| SBR-3 | Parts by mass | | | |
| Carbon black | Parts by mass | 10 | 10 | 10 |
| Silica | Parts by mass | 90 | 90 | 90 |
| Coupling agent | Parts by mass | 9 | 9 | 9 |
| Resin-1 | Parts by mass | | 45 | 20 |
| Resin-2 | Parts by mass | | | |
| Resin-3 | Parts by mass | 49 | | |
| Resin-4 | Parts by mass | | | |
| Liquid rubber | Parts by mass | | | |
| Oil | Parts by mass | 0 | 10 | 20 |
| Resin + plasticizer | (parts by mass) | 49 | 55 | 40 |
| Resin mass | % | 100 | 81.8 | 50 |
| proportion | | | | |
| Difference | ° C. | 150 | 119 | 119 |
| Tgr − Tgp | | | | |
| Difference | ° C. | 20 | 17 | 4 |
| \|σbf − σaf\| | | | | |
| Difference | — | 0.180 | 0.025 | 0.015 |
| \|tanδbf − tanδaf\| | | | | |
| Wear resistance | Index value | 155 | 120 | 108 |
| Wet performance | Index value | 115 | 114 | 104 |
| Rolling resistance | Index value | 83 | 92 | 100 |

TABLE 2-1

| | | Exam- | Exam- | Exam- | Exam- |
|---|---|---|---|---|---|
| | | ple 1 | ple 2 | ple 3 | ple 4 |
| NR | Parts by mass | | | | |
| SBR-1 | Parts by mass | 80 | 90 | 80 | 75 |
| SBR-2 | Parts by mass | 20 | 10 | 20 | 25 |
| SBR-3 | Parts by mass | | | | |
| Carbon black | Parts by mass | 10 | 10 | 10 | 10 |
| Silica | Parts by mass | 90 | 90 | 90 | 90 |
| Coupling agent | Parts by mass | 9 | 9 | 9 | 9 |
| Resin-1 | Parts by mass | 30 | 40 | | |
| Resin-2 | Parts by mass | | | 30 | |
| Resin-3 | Parts by mass | | | | 17 |
| Resin-4 | Parts by mass | | | | |
| Liquid rubber | Parts by mass | | | | |
| Oil | Parts by mass | 10 | 0 | 10 | 3 |
| Resin + | (parts by mass) | 40 | 40 | 40 | 20 |
| plasticizer | | | | | |
| Resin mass | % | 75 | 100 | 75 | 85 |
| proportion | | | | | |
| Difference | ° C. | 119 | 119 | 118 | 150 |
| Tgr − Tgp | | | | | |
| Difference | ° C. | 6 | 8 | 6 | 10 |
| \|σbf − σaf\| | | | | | |
| Difference | — | 0.012 | 0.018 | 0.01 | 0.012 |
| \|tanδbf − tanδaf\| | | | | | |
| Wear resistance | Index value | 132 | 141 | 132 | 115 |
| Wet performance | Index value | 114 | 117 | 113 | 111 |
| Rolling resistance | Index value | 100 | 98 | 101 | 100 |

TABLE 2-2

| | | Exam- | Exam- | Exam- | Exam- |
|---|---|---|---|---|---|
| | | ple 5 | ple 6 | ple 7 | ple 8 |
| NR | Parts by mass | 15 | 10 | | |
| SBR-1 | Parts by mass | 60 | 90 | | 80 |
| SBR-2 | Parts by mass | 25 | | | 20 |
| SBR-3 | Parts by mass | | | 100 | |
| Carbon black | Parts by mass | 10 | 10 | 10 | 10 |
| Silica | Parts by mass | 100 | 90 | 100 | 90 |
| Coupling agent | Parts by mass | 9 | 9 | 9 | 9 |
| Resin-1 | Parts by mass | 30 | 30 | 30 | 30 |
| Resin-2 | Parts by mass | | | | |
| Resin-3 | Parts by mass | | | | |
| Resin-4 | Parts by mass | | | | |
| Liquid rubber | Parts by mass | | | | 10 |
| Oil | Parts by mass | 10 | 0 | 10 | 0 |
| Resin + | (parts by mass) | 40 | 30 | 40 | 40 |
| plasticizer | | | | | |
| Resin mass | % | 75 | 100 | 75 | 75 |
| proportion | | | | | |
| Difference | ° C. | 119 | 119 | 138 | 119 |
| Tgr − Tgp | | | | | |
| Difference | ° C. | 8 | 6 | 8 | 6 |
| \|σbf − σaf\| | | | | | |
| Difference | — | 0.012 | 0.012 | 0.01 | 0.013 |
| \|tanδbf − tanδaf\| | | | | | |
| Wear resistance | Index value | 130 | 142 | 145 | 130 |
| Wet performance | Index value | 113 | 112 | 111 | 117 |
| Rolling resistance | Index value | 97 | 100 | 103 | 100 |

Types of the used raw materials in Tables 1 and 2 are described below.
NR: Natural rubber; TSR20; glass transition temperature: −65° C.
SBR-1: Terminal-modified styrene-butadiene rubber having a polyorganosiloxane structure; Nipol NS612, available from Zeon Corporation; glass transition temperature: −61° C.; styrene content: 15 mass %; vinyl content: 31%; non-oil extended product
SBR-2: Terminal-modified styrene-butadiene rubber having a polyorganosiloxane structure: Nipol NS616, available from Zeon Corporation; glass transition temperature: −23° C.; styrene content: 22 mass %; vinyl content: 67%; non-oil extended product
SBR-3: Terminal-modified styrene-butadiene rubber having a polyorganosiloxane structure; prototype SBR from Yokohama Rubber Co., Ltd.; glass transition temperature: −80° C.; styrene content: 6 mass %; vinyl content: 15%; non-oil extended product
Carbon black: SEAST 7HM, available from Tokai Carbon Co., Ltd.
Silica: Zeosil 1165MP, available from Solvay; nitrogen adsorption specific surface area: 159 m2/g
Coupling agent: Silane coupling agent; Si69, available from Evonik Degussa
Resin-1: C9 petroleum resin, Neopolymer S100, available from ENEOS Corporation; glass transition temperature: 58° C.
Resin-2: Aromatic modified terpene resin; YS resin TO-105, available from Yasuhara Chemical Co., Ltd.; glass transition temperature: 57° C.
Resin-3: Indene resin; FMR0150, available from Mitsui Chemicals, Inc.; glass transition temperature: 89° C.
Resin-4: Phenol modified terpene resin; Tamanol 803L, available from Arakawa Chemical Industries, Ltd.; glass transition temperature: 95° C.
Liquid rubber: Liquid styrene-butadiene rubber, Ricon 100, available from Cray Valley
Oil: Extract No. 4S, available from Shell Lubricants Japan K.K.

TABLE 3
Common additive formulation

| | | |
|---|---|---|
| Anti-aging agent | 3.0 | Parts by mass |
| Wax | 1.0 | Parts by mass |
| Sulfur | 2.0 | Parts by mass |
| Vulcanization accelerator | 1.5 | Parts by mass |

Types of the used raw materials in Table 3 are described below.
Anti-aging agent: VULANOX 4020, available from Lanxess AG
Wax: OZOACE-0015A, available from Nippon Seiro Co., Ltd.
Sulfur: SULFAX 5, available from Tsurumi Chemical Industry Co., Ltd.
Vulcanization accelerator: NOCCELER CZ-G, available from Ouchi Shinko Chemical Industrial Co., Ltd.

As can be seen from Tables 1 and 2, it was confirmed that each rubber composition of Examples 1 to 8 had excellent wear resistance, wet performance, and low rolling resistance.

As clearly shown in Table 1, since the rubber composition of Comparative Example 1 had the proportion of the thermoplastic resin of less than 75 mass % with respect to the total amount of the thermoplastic resin and the plasticizer and the difference | σbf-σaf| of less than 4° C., wear resistance and wet performance could not be improved to suitable levels.

Since the rubber composition of Comparative Example 2 had the total amount of the thermoplastic resin and the plasticizer of less than 20 parts by mass and the difference | σbf-σaf| of less than 4° C., wear resistance and wet performance could not be improved to suitable levels.

Since the rubber composition of Comparative Example 3 had the difference | tan δbf-tan δaf| of more than 0.02, wet performance and rolling resistance deteriorated.

Since the rubber composition of Comparative Example 4 had the difference | tan δbf-tan δaf| of more than 0.02, rolling resistance deteriorated.

Since the rubber composition of Comparative Example 5 had the total amount of the thermoplastic resin and the plasticizer of 50 parts by mass or more, rolling resistance deteriorated.

Since the rubber composition of Comparative Example 6 had the proportion of the thermoplastic resin of less than 75 mass % with respect to the total amount of the thermoplastic resin and the plasticizer, wear resistance and wet performance could not be improved to suitable levels.

The present disclosure includes the following technologies.

Technology [1] A rubber composition containing:
in 100 parts by mass of a diene rubber containing at least one styrene-butadiene rubber,
from 20 to 150 parts by mass of a white filler, and
a total of 20 parts by mass or more and less than 50 parts by mass of a thermoplastic resin and, optionally, a plasticizer;
a proportion of the thermoplastic resin with respect to a total amount of the thermoplastic resin and the plasticizer being 75 mass % or more; and the rubber composition satisfying relationship formulas (1) and (2) below:

σbf-σaf≥4 (1)

|tan δbf-tan δaf|≤0.02 (2)
where σbf (° C.) represents a half-width in a temperature dependent tan δ curve of the rubber composition, tan δbf represents a value of tan δ at a temperature 90° C. higher than a peak temperature where tan δ is at maximum, σaf (° C.) represents a half-width of a temperature dependent tan δ curve of a treated rubber composition by immersion of the rubber composition in toluene and drying, and tan δaf represents a value of tan δ at a temperature 90° C. higher than a peak temperature where tan δ is at maximum.

Technology [2] The rubber composition according to Technology [1], where a difference Tgr-Tgp between a minimum glass transition temperature Tgp (° C.) among glass transition temperatures of the at least one styrene-butadiene rubber and a glass transition temperature Tgr (° C.) of the thermoplastic resin is 100° C. or more.

Technology [3] The rubber composition according to Technology [1] or [2], where the diene rubber contains from 70 to 100 mass % of the at least one styrene-butadiene rubber and from 0 to 30 mass % of an isoprene-based rubber.

Technology [4] The rubber composition according to any one of Technologies [1] to [3], where at least one of terminals of the at least one styrene-butadiene rubber is modified with a functional group.

Technology [5] The rubber composition according to any one of Technologies [1] to [4], where
a glass transition temperature Tgr of the thermoplastic resin is from 40 to 120° C.; and
the thermoplastic resin is at least one selected from the group consisting of a resin containing at least one selected from a terpene, a modified terpene, a rosin, a rosin ester, a C5 component, and a C9 component, and a resin with at least some of double bonds of the resin being hydrogenated.

1. A rubber composition comprising:
in 100 parts by mass of a diene rubber containing at least one styrene-butadiene rubber,
from 20 to 150 parts by mass of a white filler, and
a total of 20 parts by mass or more and less than 50 parts by mass of a thermoplastic resin and, optionally, a plasticizer;
a proportion of the thermoplastic resin with respect to a total amount of the thermoplastic resin and the plasticizer being 75 mass % or more; and
the rubber composition satisfying relationship formulas (1) and (2):

|σbf-σaf|≥4 (1)

|tan δbf-tan δaf|≤0.02 (2)
where σbf (° C.) represents a half-width in a temperature dependent tan δ curve of the rubber composition, tan δbf represents a value of tan δ at a temperature 90° C. higher than a peak temperature where tan δ is at maximum, σaf (° C.) represents a half-width of a temperature dependent tan δ curve of a treated rubber composition by immersion of the rubber composition in toluene and drying, and tan δaf represents a value of tan δ at a temperature 90° C. higher than a peak temperature where tan δ is at maximum.

2. The rubber composition according to claim 1, wherein a difference Tgr-Tgp between a minimum glass transition temperature Tgp (° C.) among glass transition temperatures of the at least one styrene-butadiene rubber and a glass transition temperature Tgr (° C.) of the thermoplastic resin is 100° C. or more.

3. The rubber composition according to claim 1, wherein the diene rubber contains from 70 to 100 mass % of the at least one styrene-butadiene rubber and from 0 to 30 mass % of an isoprene-based rubber.

4. The rubber composition according to claim 1, wherein at least one of terminals of the at least one styrene-butadiene rubber is modified with a functional group.

5. The rubber composition according to claim 1, wherein
a glass transition temperature Tgr of the thermoplastic resin is from 40 to 120° C.; and
the thermoplastic resin is at least one selected from the group consisting of a resin containing at least one selected from a terpene, a modified terpene, a rosin, a rosin ester, a C5 component, and a C9 component, and a resin with at least some of double bonds of the resin being hydrogenated.

6. The rubber composition according to claim 2, wherein the diene rubber contains from 70 to 100 mass % of the at least one styrene-butadiene rubber and from 0 to 30 mass % of an isoprene-based rubber.

7. The rubber composition according to claim 2, wherein at least one of terminals of the at least one styrene-butadiene rubber is modified with a functional group.

8. The rubber composition according to claim 2, wherein
a glass transition temperature Tgr of the thermoplastic resin is from 40 to 120° C.; and
the thermoplastic resin is at least one selected from the group consisting of a resin containing at least one selected from a terpene, a modified terpene, a rosin, a rosin ester, a C5 component, and a C9 component, and a resin with at least some of double bonds of the resin being hydrogenated.
